(19) United States
(12) Patent Application Publication
(10) Pub. No.: US 2022/0074513 A1
(43) Pub. Date: Mar. 10, 2022

(54) ELECTROMECHANICAL DEVICE WITH AN ACTUATOR DRIVE AND AN ACTUATOR

(71) Applicant: HELLA GmbH & Co. KGaA, Lippstadt (DE)

(72) Inventors: Hagen MUELLER, Bad Wuennenberg (DE); Sebastian TIEMEYER, Dortmund (DE)

(73) Assignee: HELLA GmbH & Co. KGaA, Lippstadt (DE)

(21) Appl. No.: 17/531,338

(22) Filed: Nov. 19, 2021

Related U.S. Application Data
(63) Continuation of application No. PCT/EP2020/063494, filed on May 14, 2020.

(30) Foreign Application Priority Data
May 20, 2019 (DE) 10 2019 113 274.6

(51) Int. Cl. F16K 31/04; F16H 57/021; H02K 7/116; H02K 26/00

(52) U.S. Cl. CPC F16K 31/043; F16H 57/021; F16H 2057/02034; H02K 26/00; H02K 7/116

(57) ABSTRACT

An electromechanical device, having an actuator drive, which may be electrically actuated with the aid of a controller, and an actuator, which may be driven with the aid of the actuator drive and includes a housing, the actuator drive including an electric motor and a transmission, and the actuator drive having at least one electric line for electrical connection to the controller, and the electric motor being connected in a torque-transmitting manner to the actuator with the aid of the transmission. To improve an electromechanical device, it is proposed that the actuator drive is arranged entirely in the housing of the actuator up to the electric line.

This nonprovisional application is a continuation of International Application No. PCT/EP2020/063494, which was filed on May 14, 2020, and which claims priority to German Patent Application No. 10 2019 113 274.6, which was filed in Germany on May 20, 2019, and which are both herein incorporated by reference.

### BACKGROUND OF THE INVENTION

### Field of the Invention

The present invention relates to an electromechanical device including an actuator drive and an actuator.

### Description of the Background Art

Electromechanical devices are known from the prior art in numerous design variants.

The known electromechanical devices comprise an actuator drive, which may be electrically actuated with the aid of a controller, and an actuator, which may be driven with the aid of the actuator drive and includes a housing, the actuator drive including an electric motor and a transmission, and the actuator drive having at least one electric line for electrically connecting to the controller, and an output shaft of the electric motor being connected in a torque-transmitting manner to the actuator with the aid of the transmission.

### SUMMARY OF THE INVENTION

It is therefore an object of the present improve an electromechanical device.

This object is achieved by an electromechanical device, which is characterized in that the actuator drive is arranged entirely in the housing of the actuator up to the electric line.

An essential advantage of the invention is that an electromechanical device is improved by largely integrating the actuator drive into the housing of the actuator, a sealing of the housing against the surroundings is structurally much improved. For example, because no mechanically movable parts of the actuator drive must be inserted into the housing of the actuator from the outside, a sealing device designed in this manner, at least one shaft sealing ring or the like, is unnecessary. The number of necessary components may also be reduced accordingly. A more compact design is made possible thereby, so that the electromechanical device according to the invention may be implemented in a space-saving manner. Moreover, an energy-efficient design of the electromechanical device according to the invention is made possible, since the electric motor of the actuator drive does not have to overcome a mechanical resistance of the aforementioned sealing device, which would otherwise be necessary, for example the at least one shaft sealing ring.

In principle, the housing of the actuator is freely selectable within broad, suitable parameters, according to the type, dimensioning, material and spatial design. One advantageous refinement of the electromechanical device according to the invention provides that the housing is designed as a two-part housing. In this way, the actuator and the actuator drive may be easily installed in the housing.

A further advantageous refinement of the electromechanical device provides that the transmission includes at least one gear stage with a cycloidal drive, a pin ring of the cycloidal drive being arranged at the housing in a force-transmitting manner. Cycloidal drives transmit torques in a rolling manner so that no toothed wheels are necessary. Cycloidal drives are also not subjected to shear forces. Furthermore, abrupt failures are not possible in the case of cycloidal drives. Moreover, cycloidal drives offer a low-wear operation and are very robust. Cycloidal drives also promote a compact design of the electromechanical device according to the invention, so that the necessary space requirements are further reduced. In addition, on the one hand, a fixing of the pin ring is implemented by this refinement in a structurally simple manner. On the other hand, a space-saving specific embodiment of the transmission is made possible thereby. The pin ring may be detachably or non-detachably connectable to the housing. It is furthermore possible to manufacture the in ring and the housing from different materials. Accordingly, the material for the pin ring and the material for the housing may be adapted to the particular function.

The pin ring can be designed as an integral part of the housing. The degree of integration of the actuator drive is further increased hereby. Moreover, this allows for further savings in components and installation space.

An output shaft of the cycloidal drive can be rotatably supported on a stationary bearing axis, the bearing axis being supported on the housing on one side. In this way, on the one hand, the force-transmitting connection between the bearing axis and the housing is implemented in a particularly structurally simple manner. On the other hand, the design flexibility in constructing the electrical device according to the invention is much improved by the one-sided supporting of the bearing axis on the housing.

The bearing axis of the electromechanical device according to the invention is freely selectable within broad, suitable parameters, according to the type, material, dimensioning and arrangement. A further advantageous refinement of the electromechanical device according to the invention provides that the bearing axis is designed as an axis made from metal, in particular as a steel axis. In this way, the bearing axis has a robust and long-lasting design. In addition, a low-friction and thus energy-saving as well as low-wear supporting of the first output shaft on the bearing axis is made possible by a combination of the bearing axis designed as a metal axis, preferably as a steel axis, on the one hand, and a first output shaft manufactured, for example, from a plastic, on the other hand.

The supporting and thus the force-transmitting connection between the bearing axis and the housing are freely selectable within broad, suitable parameters. One advantageous refinement of the aforementioned specific embodiment of the electromechanical device according to the invention provides that the bearing axis is designed as an integral part of the housing. In this way, the degree of integration, and thus the savings in components and installation space, is further increased. The manufacturing complexity in manufacturing the electromechanical device according to the invention is also reduced thereby.

The electromechanical device according to the invention is freely selectable within broad, suitable parameters, according to the type, functionality, material, dimensioning and use. The electrical device can be advantageously designed as a valve, the actuator being designed as a valve body of the valve.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an exemplary embodiment of the electromechanical device according to the invention in a cutaway view from below;

FIG. 2 shows the exemplary embodiment in a cutaway side view; and

FIG. 3 shows the exemplary embodiment in a cutaway top view.

### DETAILED DESCRIPTION

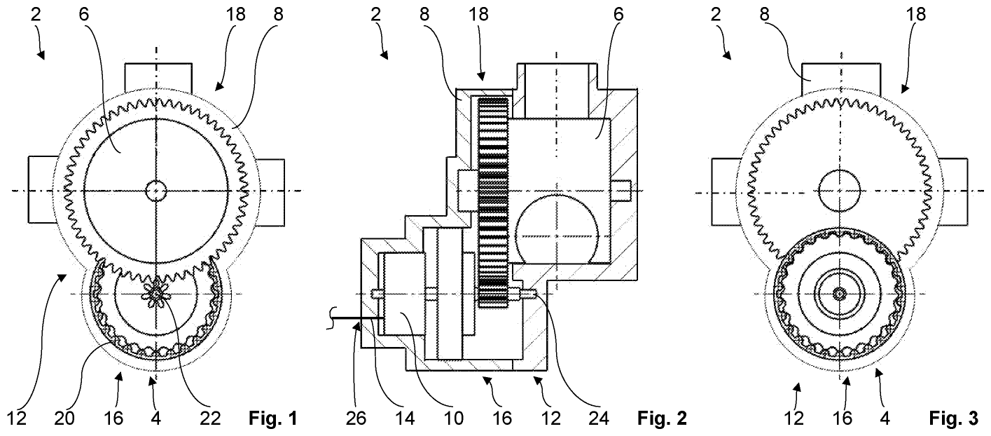

FIGS. 1 through 3 show an exemplary embodiment of the electromechanical device according to the invention by way of example.

Electromechanical device 2 is designed as a coolant valve for a motor vehicle, and comprises an actuator drive 4, which may be electrically actuated with the aid of a controller, and an actuator 6 which may be driven with the aid of actuator drive 4 and includes a housing 8, actuator drive 4 including an electric motor 10 and a transmission 12, and actuator drive 4 having at least one electric line 14 for electrically connecting to the controller, and electric motor 10 being connected in a torque-transmitting manner to actuator 6 with the aid of transmission 12. In the present exemplary embodiment, actuator 6 is designed as a valve body of coolant valve 2. Actuator drive 4 is arranged entirely in housing 8 of actuator 6 up to electric line 14. A coolant flow of a coolant of the motor vehicle may be controlled or regulated with the aid of coolant valve 2 in a manner known to those skilled in the art. Housing 8 is designed as a two-part housing.

Transmission 12 comprises a first gear stage 16 and a second gear stage 18, first gear stage 16 of transmission 12 being designed as a cycloidal drive, and a pin ring 20 of cycloidal drive 16 being arranged in a force-transmitting manner on housing 8. it is conceivable, for example, that pin ring 20 is detachably or non-detachably arranged on housing 8 of actuator 6 of electromechanical device 2. First gear stage 16 is connected in a torque-transmitting manner to second gear stage 18 in a manner known to those skilled in the art and apparent from FIGS. 1 through 3. Second gear stage 18 is furthermore connected in a torque-transmitting manner to actuator 6 designed as a valve body of electromechanical device 2 designed as a coolant valve in a manner known to those skilled in the art and apparent from FIGS. 1 through 3.

The individual parts of first gear stage 16 designed as a cycloidal drive and second gear stage 18 could each be designed, for example, as a plastic part. Due to the different functions and friction pairings, these plastic parts could be designed accordingly specifically in a manner suitable for the particular function and/or for the particular friction pairing.

An output shaft 22 of cycloidal drive 16 is rotatably supported on a stationary bearing axis 24, bearing axis 24 being designed as a metal axis, namely a steel axis, and being fixed on housing 8 in a manner known to those skilled in the art, and bearing axis 24 being supported on housing 8 on one side in the present exemplary embodiment.

As is clearly apparent from FIGS. 1 through 3, actuator drive 4 is arranged in housing 8 of actuator 6, with the exception of electric line 14. Only electric line 14 is guided through housing 8 to the outside. Accordingly, housing 8 is to be sealed in a manner known to those skilled in the art only at one feed-through point 26 of housing 8 with the aid of a sealing device suitable for the particular application. By largely integrating actuator drive 4 into housing 8 of actuator 6, the sealing of housing 8 against the surroundings is structurally much improved. For example, because no mechanically movable parts must be inserted into housing 8 of actuator 6 from the outside, a sealing device designed in this manner, at least one shaft sealing ring, is unnecessary. The number of necessary components is therefore reduced. A more compact design is also made possible thereby, so that the electromechanical device according to the invention may be implemented in a space-saving manner according to the present specific embodiment. Moreover, an energy-efficient design of the electromechanical device according to the invention is made possible according to the present exemplary embodiment, since electric motor 10 of actuator drive 4 does not have to overcome a mechanical resistance of the aforementioned sealing device, which would otherwise be necessary, for example the at least one shaft sealing ring.

The functionality of the electromechanical device according to the invention is explained in greater detail below according to the present exemplary embodiment, based on FIGS. 1 through 3.

Electromechanical device 2 designed as a coolant valve for a motor vehicle is in a certain operating position. Accordingly, valve body 6 of coolant valve 2 is in a certain position, in which it blocks or permits a coolant flow, for example.

Due to an automatic actuation of electric motor 10 of coolant valve 2 with the aid of a controller of the motor vehicle, first gear stage 16 of transmission 12 is driven with the aid of electric motor 10 in a manner known to those skilled in the art. Due to the torque-transmitting connection between first gear stage 16 and second gear stage 18, the rotation of first gear stage 16 is transmitted in a manner known to those skilled in the art to second gear stage 18, the rotation ultimately being converted into a rotation of valve body 6 of coolant valve 2. Accordingly, the operating position of valve body 6 of coolant valve 2 changes, so that coolant valve 2 blocks or permits the coolant flow with the aid of the position of valve body 6 of coolant valve 2, which is changed in the manner explained above, according to the automatic actuation with the aid of the controller of the motor vehicle.

The invention is not limited to present exemplary embodiment. For example, the electromechanical device according to the invention as well as the transmission according to the invention are freely selectable within broad, suitable parameters and are not limited to the application in a valve, for example a coolant valve for a motor vehicle. Accordingly, the invention may be advantageously used in a multiplicity of different applications.

In contrast to the present exemplary embodiment, it is furthermore conceivable that the pin ring is designed as an integral part of the housing. It is also possible that the bearing axis is alternatively or additionally designed as an integral part of the housing.

The invention being thus described, it will be obvious that the same may be varied in many ways. Such variations are not to be regarded as a departure from the spirit and scope of the invention, and all such modifications as would be obvious to one skilled in the art are to be included within the scope of the following claims

What is claimed is:

1. An electromechanical device comprising:
an actuator drive adapted to be electrically actuated via a controller; and
an actuator adapted to be driven via the actuator drive, the actuator comprising a housing,
wherein the actuator drive comprises an electric motor, a transmission, and at least one electric line for electrically connecting to the controller,
wherein the electric motor is connected in a torque-transmitting manner to the actuator via the transmission, and
wherein the actuator drive is arranged entirely in the housing of the actuator up to the electric line.

2. The electromechanical device according to claim 1, wherein the housing is a two-part housing.

3. The electromechanical device according to claim 1, wherein the transmission includes at least one gear stage, including a cycloidal drive, a pin ring of the cycloidal drive being arranged on the housing in a force-transmitting manner.

4. The electromechanical device according to claim 3, wherein the pin ring is an integral part of the housing.

5. The electromechanical device according to claim 1, wherein an output shaft of the cycloidal drive is rotatably supported on a stationary bearing axis, the bearing axis being supported on the housing on one side.

6. The electromechanical device according to claim 5, wherein the bearing axis is designed as an integral art of the housing.

7. The electromechanical device according to claim 1, wherein the electromechanical device is a valve, the actuator being designed as a valve body of the valve.
